(19) United States
(12) Patent Application Publication
(10) Pub. No.: US 2011/0225434 A1
(43) Pub. Date: Sep. 15, 2011

(54) MICROCOMPUTER CONTROLLER

(76) Inventor: Masaru Nishikawa, Tokyo (JP)

(21) Appl. No.: 12/672,242

(22) PCT Filed: Jul. 2, 2008
(86) PCT No.: PCT/JP2008/001742

§ 371 Date: Feb. 4, 2010

(30) Foreign Application Priority Data
Oct. 9, 2007 (JP) 2007-263570

(51) Int. Cl. G06F 1/26

(52) U.S. Cl. 713/300

(57) ABSTRACT

A microcomputer controller includes a power operating means for controlling switching on and off of a switch for switching on and off power supply for a microcomputer operation unit, and a startup and shutdown means for, in response to a signal from a microcomputer operation judging unit, starting up or shutting down a microcomputer and also furnishing a power off signal to the power operating means, for writing a SUM value of used data of a RAM in an empty space of this RAM at a time of shutdown of supply of electric power to the microcomputer, and for comparing a SUM value of the RAM with the written SUM value at a time of supply of the electric supply to the microcomputer, and performing a resume operation when they are equal to each other whereas performing a reset operation when they are different from each other.

### FIELD OF THE INVENTION

The present invention relates to a microcomputer controller in which a power supply used for a microcomputer operation unit and a power supply used for a RAM unit in a microcomputer are separately disposed.

### BACKGROUND OF THE INVENTION

Conventionally, in such a type of microcomputer controller, in case in which a power supply used for a microcomputer operation unit is identical to a power supply used for a RAM unit in a microcomputer, electric power is supplied to the microcomputer also in low consumption mode of the microcomputer and the low consumption mode can be implemented by halting the supply of a clock signal to the microcomputer.

Furthermore, as disclosed in patent reference 1, in order to prevent disappearance of data in a RAM of the microcomputer and initialization of the RAM through a reset of the microcomputer which is caused by an instantaneous interruption of the power supply voltage applied to the microcomputer, comparison between data in a nonvolatile memory and data in a volatile memory is carried out.
[Patent reference 1] JP,11-085333,A ([0012] and [0021], and FIG. 1)

Because the conventional microcomputer controller is constructed as mentioned above, in case in which the power supply used for the microcomputer operation unit is identical to the power supply used for the RAM unit in the microcomputer, the low consumption mode is implemented by halting the supply of the clock signal to the microcomputer, though it is difficult to provide a further-lowered power consumption state.

In a conventional microcomputer controller in which a power supply used for a microcomputer operation unit and a power supply used for a RAM unit in a microcomputer are separately disposed, the microcomputer is reset when the power supply for the microcomputer is disconnected, and therefore a state in which the microcomputer has been placed before switching to the low consumption mode cannot be held. In order to hold the state in which the microcomputer has been placed before switching to the low consumption mode even if the microcomputer is reset, a process of holding information about the microcomputer's state in a nonvolatile memory, and so on are required. However, the conventional microcomputer controller cannot judge whether to perform a reset operation (an initial operation) or a resume operation (a subsequent operation) at the time of supply of electric power to the microcomputer. A further problem is that the conventional microcomputer controller does not judge whether the data stored in the RAM (nonvolatile memory) can be trusted.

The present invention is made in order to solve the above-mentioned problems, and it is therefore an object of the present invention to provide a microcomputer controller that can judge whether to perform either a reset operation or a resume operation when causing a microcomputer to return from a low consumption state in which supply of electric power to a microcomputer operation unit is shut down (interrupted) so as to cause the microcomputer to perform an intended reset operation.

### DISCLOSURE OF THE INVENTION

In accordance with the present invention, there is provided a microcomputer controller including: a switch for switching on and off power supply for a microcomputer operation unit; a power control circuit having a microcomputer operation judging unit for judging whether the microcomputer is in an ON state or an OFF state in response to a power supply voltage drop detection signal and a user operation signal, and a power operating means for controlling the switching on and off of the switch; and a startup and shutdown means for, in response to a signal from the microcomputer operation judging unit, starting up or shutting down the microcomputer and also furnishing a power off signal to the power operating means, for writing a SUM value of used data of a RAM in an empty space of this RAM at a time of shutdown of supply of electric power to the microcomputer, and for comparing a SUM value of the RAM with the written SUM value at a time of supply of the electric supply to the microcomputer, and performing a resume operation when they are equal to each other whereas performing a reset operation when they are different from each other.

The microcomputer controller in accordance with the present invention is constructed in such a way as to write the SUM value of the used data in the RAM in a free space at the time of shutdown of the supply of the electric power to the microcomputer, compare the SUM value of the RAM with the written SUM value at the time of supply of the electric power to the microcomputer, and perform the resume operation when the SUM value of the RAM is equal to the written SUM value whereas perform the reset operation when the SUM value of the RAM is different from the written SUM value. Therefore, the microcomputer controller has an advantage of being able to determine whether to perform the reset operation or the resume operation when the microcomputer operation unit returns from a low consumption state which is caused by a power supply shutdown to enable the microcomputer to carry out an intended reset operation, and so on.

### BRIEF DESCRIPTION OF THE FIGURES

FIG. 1 is a block diagram showing the whole configuration of a microcomputer controller in accordance with Embodiment 1 of the present invention;

FIG. 2 is a flow chart explaining an operation of shutting down supply of electric power;

FIG. 3 is a flow chart explaining an operation of supplying electric power; and

FIG. 4 is a flow chart explaining another example of the operation of supplying electric power.

### PREFERRED EMBODIMENTS OF THE INVENTION

### Embodiment 1

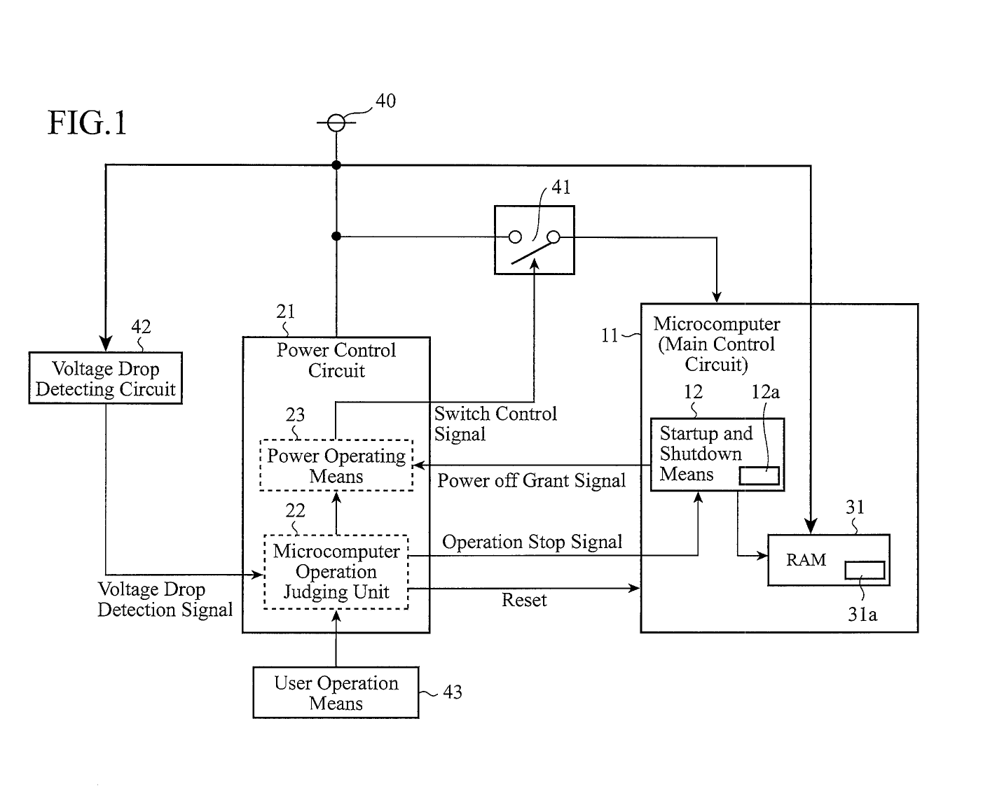

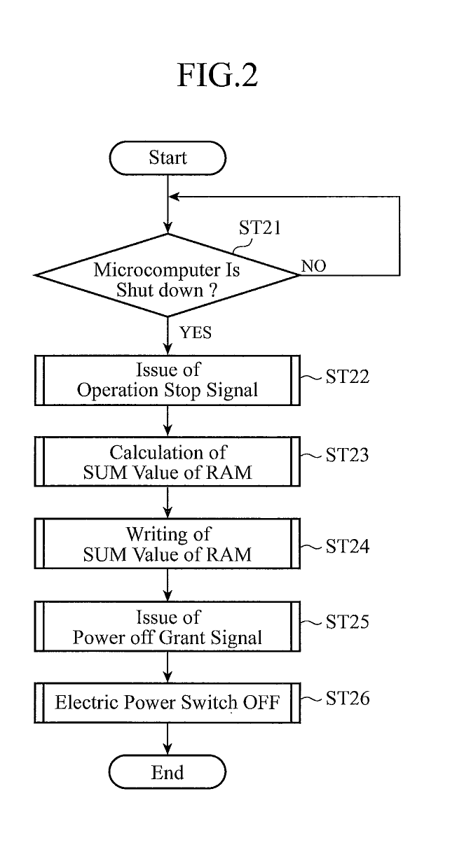

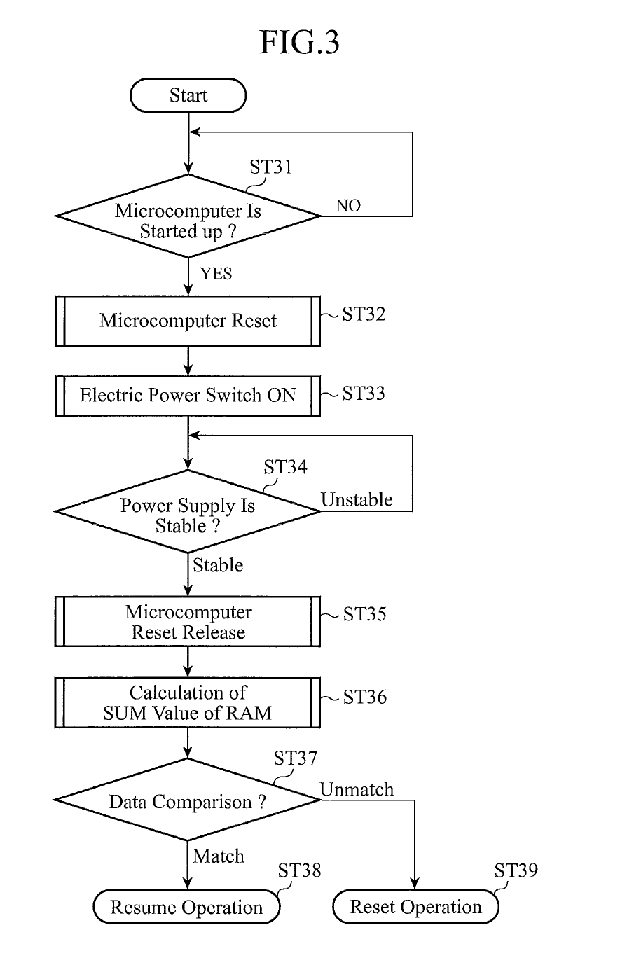

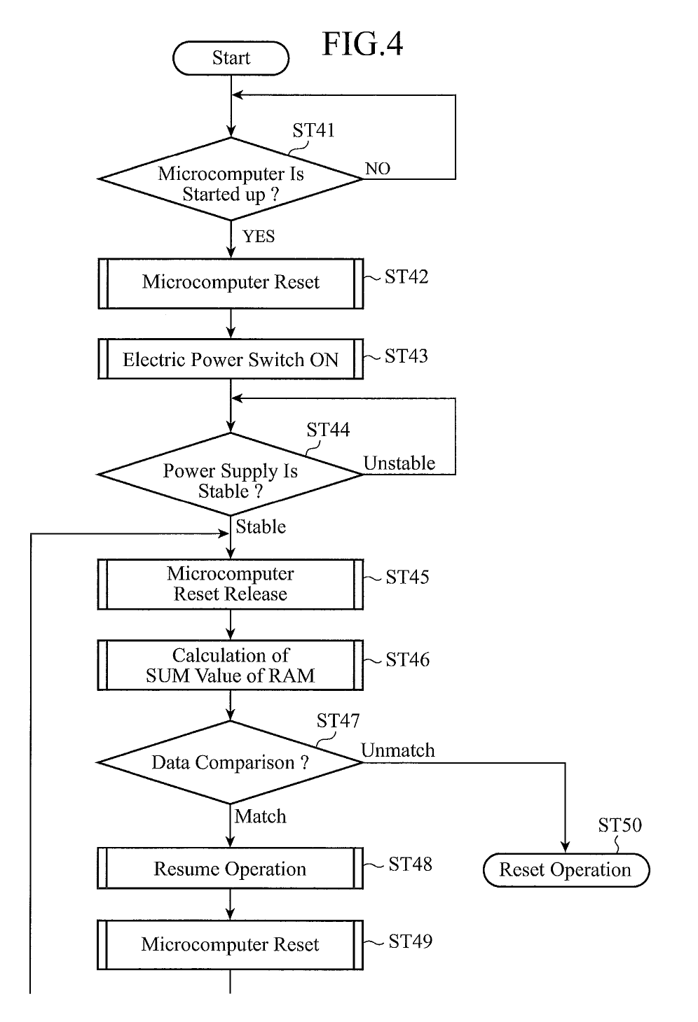

FIG. 1 is a block diagram showing the whole configuration of a microcomputer controller in accordance with Embodiment 1 of the present invention, FIG. 2 is a flow chart explaining an operation of shutting down the microcomputer, FIG. 3 is a flow chart explaining an operation of starting up the microcomputer and judging whether to perform either a resume operation of making the microcomputer resume operation or a reset operation of resetting the microcomputer, and FIG. 4 is a flow chart explaining another example of the operation of starting up the microcomputer.

In FIG. 1, a power supply 40 always supplies electric power to a power control circuit 21 and a RAM (nonvolatile memory) 31 of the microcomputer 11, and also supplies electric power to the microcomputer 11 via a switch 41. The power control circuit 21 has a microcomputer operation judging unit 22 and a power operating means 23. The microcomputer 11 has a startup and shutdown means 12 and the RAM (nonvolatile memory) 31.

A voltage drop detecting circuit 42 detects a voltage drop of the power supply 40, and furnishes a voltage drop detection signal to the microcomputer operation judging unit 22. ON/OFF control of the switch 41 is carried out by the power operating means 23.

In response to either the voltage drop detection signal from the voltage drop detecting circuit 42 or a user operation signal from a user operation means 43, the microcomputer operation judging unit 22 furnishes an operation stop signal to the startup and shutdown means 12 and also resets the microcomputer 11. The startup and shutdown means 12 furnishes a power off grant signal to the power operating means 23, and the power operating means 23 furnishes a switch control signal to the switch 41.

Next, the operation of the microcomputer controller will be explained. First, referring to FIG. 2, a power supply shutdown operation will be explained. When receiving either a voltage drop detection signal from the voltage drop detecting circuit 42 or a device shutdown command from the user operation means 43, the microcomputer operation judging unit 22 of the power control circuit 21 judges whether or not the microcomputer is shut down (step ST21), and, when judging that the microcomputer is shut down, issues an operation stop signal to the startup and shutdown means 12 (step ST22).

When receiving the operation stop signal furnished thereto, the startup and shutdown means 12 calculates a SUM value of all used data in the RAM 31 (step ST23), writes this SUM value in an empty space 31a of the RAM 31 (step ST24), and issues a power off grant signal to the power operating means 23 (step ST25). When receiving the power off grant signal, the power operating means 23 furnishes a switch control signal to the switch 41 so as to switch off this switch (step ST26) , thereby disconnecting the microcomputer 11 from the power supply 40 to place the power operating means 23 in the low consumption mode.

Referring to FIG. 3, the operation of supplying the electric power to the microcomputer will be explained. When detecting a return from a power supply voltage drop state or receiving the device startup command from the user operation means 43, the microcomputer operation judging unit 22 of the power control circuit 21 judges whether or not to start up the microcomputer 11 (step ST31), and, when judging that it starts up the microcomputer, instructs the power operating means 23 to turn on the supply of the electric power to the microcomputer 11 while resetting the microcomputer 11 (step ST32).

When receiving the electric power supply ON command, the power operating means 23 outputs a switch control signal to switch on the switch 41 (step ST33) to connect the power supply to the microcomputer 11. The microcomputer operation judging unit 22 judges whether the electric power supply has become stabilized (step ST34), and, when determining that the electric power supply has become stabilized, releases the reset of the microcomputer 11 (step ST35). The startup and shutdown means 12 calculates the SUM value of either all the used data or a required volume of predetermined data in the RAM 31 (step ST36), and compares this calculated SUM value with a SUM value of data in a predetermined area of the RAM 31 by using a comparator 12a (step ST37).

When the comparison result shows that they match each other, the microcomputer controller does not initialize the RAM 31, but performs a resume operation (step ST38), whereas when the comparison result shows that they do not match each other, the microcomputer controller initializes the RAM 31 and performs a reset operation (step ST39).

Referring to FIG. 4, another example of the operation of supplying the electric power to the microcomputer will be explained. Because the microcomputer controller, in steps ST41 to ST47 of FIG. 4, performs the same processes as those in steps ST31 to ST37 in FIG. 3, the duplicated explanation of the processes will be omitted hereafter. In step ST47, either a variable which is counted up (or down) with a timer or a variable which is changed after the resume operation has been performed is included in either all the used data or the predetermined data. After the microcomputer 11 performs the resume operation (step ST48), the microcomputer operation judging unit 22 resets the microcomputer 11 again (step ST49), and returns to step ST45 to release the reset after a lapse of a fixed time interval. The startup and shutdown means 12 calculates the SUM value of either all the used data or the predetermined data in the RAM 31 again, but the microcomputer 11 performs the reset operation because the calculated SUM value does not match that of the data in the predetermined area (step ST50).

The SUM value in illustrated Embodiment 1 can be the SUM value of only a required volume of data, instead of the SUM value of all the used data.

As mentioned above, the microcomputer controller in accordance with this Embodiment 1 is constructed in such a way as to write the SUM value of all the data in the RAM in a free space at the time of shutdown of the supply of the electric power to the microcomputer, compares a SUM value of the RAM with the written SUM value at the time of supply of the electric power to the microcomputer, and performs a resume operation when the SUM value of the RAM is equal to the written SUM value whereas performs a reset operation when the SUM value of the RAM is different from the written SUM value. Therefore, the microcomputer controller has an advantage of being able to determine whether to perform a reset operation or a resume operation when the microcomputer operation unit returns from a low consumption state which is caused by a power supply shutdown to enable the microcomputer to carry out an intended reset operation, and so on.

### INDUSTRIAL APPLICABILITY

As mentioned above, the microcomputer controller in accordance with the present invention can determine whether to perform a reset operation or a resume operation when the microcomputer operation unit returns from a low consumption state which is caused by a power supply shutdown, and is constructed in such a way as to, in order to enable the microcomputer to carry out an intended reset operation, write the SUM value of all the data in the RAM in a free space at the time of shutdown of the supply of the electric power to the microcomputer, compare a SUM value of the RAM with the written SUM value at the time of supply of the electric power to the microcomputer, and perform a resume operation when the SUM value of the RAM is equal to the written SUM value whereas perform a reset operation when the SUM value of the RAM is different from the written SUM value. Therefore, the microcomputer controller in accordance with the present invention is suitable for use as a microcomputer controller in which a power supply used for a microcomputer operation unit and a power supply used for a RAM unit in a microcomputer are separately disposed.

1. A microcomputer controller in which a power supply for a microcomputer operation unit and a power supply for a RAM unit in a microcomputer are separately disposed, said microcomputer controller comprising:
a switch for switching on and off the power supply for said microcomputer operation unit;
a power control circuit having a microcomputer operation judging unit for judging whether said microcomputer is in an ON state or an OFF state in response to a power supply voltage drop detection signal and a user operation signal, and a power operating unit for controlling the switching on and off of said switch; and
a startup and shutdown unit for, in response to a signal from said microcomputer operation judging unit, starting up or shutting down said microcomputer and also furnishing a power off signal to said power operating unit, for writing a SUM value of used data of a RAM in an empty space of this RAM at a time of shutdown of supply of electric power to the microcomputer, and for comparing a SUM value of said RAM with said written SUM value at a time of supply of the electric supply to said microcomputer, and performing a resume operation when they are equal to each other whereas performing a reset operation when they are different from each other.
